(19) United States
(12) Patent Application Publication
(10) Pub. No.: US 2014/0055068 A1
(43) Pub. Date: Feb. 27, 2014

(54) METHOD, DEVICE, AND COMPUTER PROGRAM FOR DETERMINING AN OFFSET ANGLE IN AN ELECTRIC MACHINE

(71) Applicants: Katharina Trautmann, Ludwigsburg (DE); Daniel Raichle, Vaihingen (DE); Gunther Goetting, Stuttgart (DE); Martin Wirth, Paris (FR)

(72) Inventors: Katharina Trautmann, Ludwigsburg (DE); Daniel Raichle, Vaihingen (DE); Gunther Goetting, Stuttgart (DE); Martin Wirth, Paris (FR)

(73) Assignee: ROBERT BOSCH GMBH, Stuttgart (DE)

(21) Appl. No.: 13/983,258

(22) PCT Filed: Feb. 2, 2012
(86) PCT No.: PCT/EP2012/051753

§ 371 Date: Aug. 1, 2013

(30) Foreign Application Priority Data
Feb. 2, 2011 (DE) 10 2011 003 500.1
Jan. 31, 2012 (DE) 10 2012 201 319.9

(51) Int. Cl. H02P 6/18

(52) U.S. Cl. CPC H02P 6/182
USPC 318/400.34

(57) ABSTRACT

The invention relates to a method and device for determining or checking the plausibility of an offset angle between an assumed orientation and an actual orientation of a rotor (20) relative to a stator (10) in an electric machine (1). In the method, the electric machine is first controlled in a quasi zero-current state, in which substantially no current should flow in the windings of the electric machine. Then a voltage indicator that specifies the direction of a voltage controlled in the electric machine during the quasi zero-current state is determined and subsequently transformed into a coordinate system that is fixed with respect to the rotor. The offset angle or an angle error with respect to a previously assumed, calibrated offset angle can be determined on the basis of the transformed voltage indicator.

### BACKGROUND OF THE INVENTION

The present invention relates to a method for determining an offset angle in an electric machine. The invention further relates to a device and a computer program which are designed to carry out the method according to the invention, and a computer-readable storage medium with a corresponding computer program stored thereon.

Electric machines with high performance potential are used in electric and hybrid vehicles for example. Here, the electric machine can be operated both in a drive mode, in which it acts as a motor, and in a generator mode, in which it converts kinetic energy into electrical energy during a braking operation. In doing so, a torque can be transmitted from the electric machine to a shaft which is connected to the electric machine and, in turn, to wheels of the vehicle for example. Here, the torque can assume positive or negative values depending on whether the electric machine is operated in drive mode or in generator mode.

Fixed-phase electric machines, such as electric synchronous machines for example, in which a rotor has the same rotational frequency as a stator rotating field, produce a torque which is highly dependent on an angular offset between rotor and stator rotating field. Further, there are a multiplicity of applications for electric machines in which an angular position of an input drive shaft of the electric machine must be synchronized with an output drive, that is to say the angular position must be accurately known.

Different angular sensor systems are known in order to be able to measure the angular position, i.e. an orientation of the rotor relative to the stator of the electric machine, As a rule, these are only fitted to the electric machine after it has been manufactured in order to be able to continuously determine information, e.g. relating to the current angular position of the input drive shaft, in subsequent operation of the electric machine. When fitting the angular sensors, it cannot always be ensured that the angular sensors can be fixed exactly at required positions with respect to the geometry of the electric machine. It can therefore come about that a zero position of an angular sensor system intended for an electric machine differs from the actual zero position of the electric machine by an angle α. This angle α is referred to herein as the offset angle. This offset angle should be known as accurately as possible and taken into account in the control of the electric machine in order to be able to realize a required torque characteristic for example.

When the electric machine and the angular sensor system have been assembled, the offset angle should therefore be determined by a calibration method. A possible calibration method is described in DE 10 2008 001 408 A1.

As the offset angle can change during the life of the electric machine, for example due to severe mechanical loads, it should be checked from time to time during the operation of the electric machine.

### SUMMARY OF THE INVENTION

There can therefore be a need to be able to check an offset angle of an electric machine during the operation of the electric machine or to be able to check the plausibility of a value of an offset angle previously obtained by calibration at a later point in time.

According to a first aspect of the present invention, a method for determining an offset angle of an electric machine is proposed. Here, the electric machine has a stator and a rotor. The method comprises the following method steps: activation of the electric machine in a quasi zero-current state; determination of a voltage vector during the quasi zero-current state; transformation of the voltage vector into a coordinate system which is fixed with respect to the rotor; and determination of the offset angle based on the transformed voltage vector.

Possible characteristics and advantages of the proposed method are described in detail below.

The electric machine is first activated in a so-called quasi zero-current state. This quasi zero-current state is defined in such a way that substantially no current flows in the windings of the electric machine. In other words, in order to achieve the quasi zero-current state, the electric machine can be activated in such a way that substantially no electric current flows in the electric machine. In doing so, the voltages applied to the windings of the electric machine can be chosen in such a way that they correspond substantially to the induced magnet wheel voltage currently prevailing in the electric machine. Expressed another way, the voltages applied to the windings of the electric machine must be adjusted in such a way that neither an electric current which would accelerate the electric machine is established in the windings nor that a significant electric current would be induced in the windings of the electric machine due to the rotor turning in the magnetic field of the electric machine.

Here, “substantially no electric current” can be understood to mean that the electric currents flowing in the windings of the electric machine are chosen to be sufficiently small that substantially no torque is transmitted to the shaft connected to the electric machine, that is to say a movement state of the shaft coupled to the electric machine is not changed by the electric machine. This applies particularly to the case where the electric machine is operated at low speeds, for example below the rated speed of the electric machine. For example, a current flowing in the windings during the quasi zero-current state can be less than 5%, preferably less than 2% of the rated current of the electric machine.

In order to be able to carry out the method for determining the offset angle, the quasi zero-current state can be brought about here by specifically activating the electric machine. As, however, the normal operation of the electric machine, that is to say for example, the driving state of a vehicle required by a driver and effected by the electric machine, could be interrupted or disrupted for this purpose, it can be preferable not to bring the electric machine specifically into a quasi zero-current state in order to then carry out the offset angle determination method, but conversely to wait until the electric machine is activated in a quasi zero-current state for other reasons and then use the opportunity to carry out the offset angle determination method. For example, in an electric vehicle, a driving situation required by the driver can arise, in which, in a manner desired by the driver, the electric machine is not to exert a torque on the shaft, that is to say is not to exert a force on the vehicle wheels, that is to say the vehicle is to be able to freewheel without force being applied by the electric machine.

The proposed offset angle determination method can be particularly advantageous, as the electric machine can be mechanically securely coupled to the shaft during the quasi zero-current state. In other words, it is not necessary to decouple the electric machine from the shaft in order to carry out the offset angle determination method; instead it is sufficient to monitor when the required quasi zero-current state is activated by an appropriate activation of the electric machine.

After the quasi zero-current state has been activated, a voltage vector, which specifies a direction of a voltage which is activated in the electric machine during the quasi zero-current state, is determined. At the same time, the voltage vector is a vectorial quantity which represents a measure of the direction and strength of the voltage distribution in the windings of the stator of the electric machine. The voltage vector will rotate synchronously with the rotor of the electric machine while the electric machine is in rotational operation.

In order to avoid such a rotation of the voltage vector in a global coordinate system, that is to say in a coordinate system which is fixed with respect to the electric machine, the voltage vector is subsequently transformed into a coordinate system which is fixed with respect to the rotor. Here, the coordinate system which is fixed with respect to the rotor is a coordinate system which is fixed relative to the rotating rotor of the electric machine, that is to say which rotates with the rotor. By transforming the voltage vector into such a coordinate system which is fixed with respect to the rotor, it can be achieved that the voltage vector is likewise stationary in a stationary state of the electric machine, that is to say has both a constant absolute value and a constant orientation. A voltage vector which is constant with respect to time and has been transformed in this way can therefore subsequently be used considerably more easily to derive further information relating to the state of the electric machine than would be the case with a rotating voltage vector which varies with respect to time. The transformation of the voltage vector can be carried out with customary mathematical methods.

In particular, the voltage vector can be transformed into the coordinate system which is fixed with respect to the rotor in such a way that a component d and a component q are to be assigned to the voltage vector in a stationary state. In other words, the transformed voltage vector should be able to be resolved into two components, in which a component d specifies the vectorial portion of the voltage vector in the direction of the electric flux, and a component q specifies the vectorial portion which is perpendicular thereto.

Finally, the offset angle can be determined based on the transformed voltage vector. In doing so, it can be established whether the transformed voltage vector which actually results when activating the electric machine in a quasi zero-current state corresponds to a required voltage indicator or a voltage indicator which has been set up as a result of the knowledge of the offset angle previously obtained by means of a calibration. In the event that the offset angle assumed on the basis of a previous calibration does not correspond to the actually determined offset angle, an angular error can be determined from the difference of the assumed and the actually determined offset angle. This angular error can be taken into account in a subsequent activation of the electric machine, that is to say the offset angle which is used by a controller of the electric machine for activating the electric machine can be corrected by the angular error.

In particular, the offset angle can be calculated from the component d and the component q of the transformed voltage vector. In particular, an angular error of the offset angle can be calculated from the component q and the component d by forming an arctan value.

The determined angular error of the offset angle can be called upon for the retrospective checking of the plausibility of the offset angle. The smaller the determined angular error, the less the offset angle obtained at an earlier point in time by calibration and assumed by the controller of the electric machine varies from the offset angle actually prevailing in the electric machine and the angular sensor system coupled thereto. If the determined angular error should exceed a specified limit value, suitable measures, such as a correction of the offset angle stored in the machine controller for example, can be taken in order to avoid damage to the electric machine or a sub-optimum control of the torque.

The method for determining the offset angle described above can be carried out, for example, by a device which is designed to control the electric machine. A computer program which, as software, can cause an appropriate control device to carry out the method steps described above, can be provided for this purpose. An appropriate computer-readable storage medium, such as for example a programmable microchip, for example an EEPROM or a CD or DVD, can contain an appropriate computer program stored thereon, thus enabling the computer program to be implemented in a programmable control device, if necessary also retrospectively.

The device designed for carrying out the method described above should be able to recognize when an electric machine is activated in a quasi zero-current state and then determine a voltage vector and transform it into a coordinate system which is fixed with respect to the rotor in order to be able to subsequently calculate an offset angle of the electric machine based on the transformed voltage vector.

The method described above and/or the device described above can be used particularly advantageously in electric vehicles or hybrid vehicles which are driven by an electric synchronous machine.

Attention is drawn to the fact that characteristics and advantages of embodiments of the invention are described herein partially with regard to the proposed method for determining an offset angle and partially with regard to a device for carrying out such a method. However, the characteristics can be combined with one another or interchanged in any way in a manner which is recognizable to a person skilled in the art.

### BRIEF DESCRIPTION OF THE DRAWINGS

Embodiments of the invention are described below with reference to the attached figures in a manner which is non-restrictive regarding the design.

FIG. 1 shows a cross section through an electric machine.

FIG. 2 shows a voltage indicator in a coordinate system which is fixed with respect to the rotor.

FIG. 3 shows an electric vehicle with a device according to the invention for determining an offset angle of an electric machine.

The figures are only roughly schematic and are not to scale.

### DETAILED DESCRIPTION

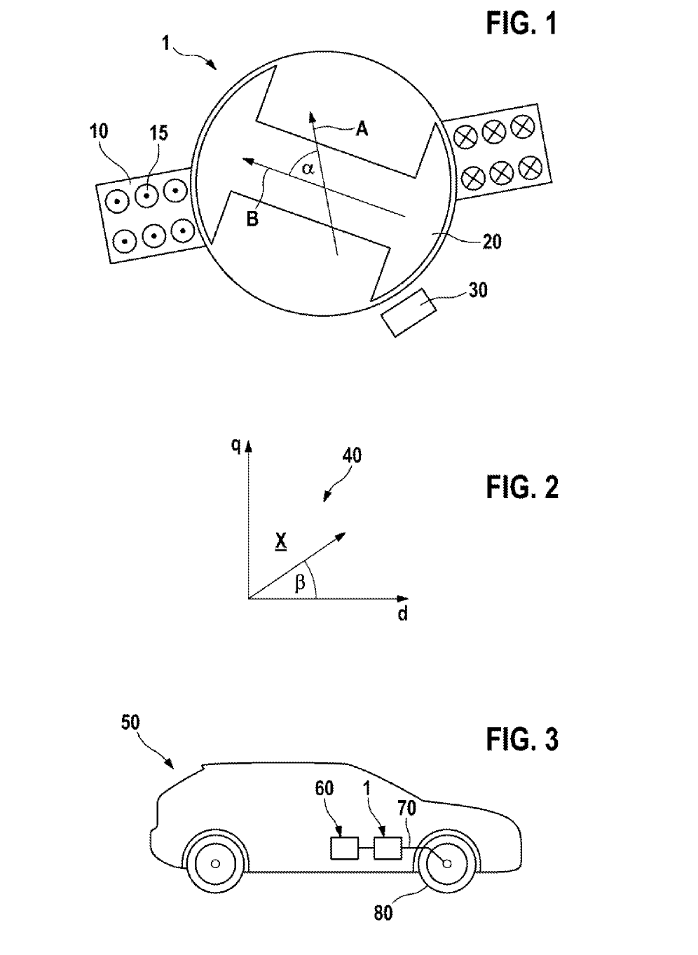

An electric machine having a stator 10, which has a plurality of stator windings 15, and a rotor 20 is shown in FIG. 1 An electric current flowing through the stator windings 15 flows out of the plane of the drawing in a winding section shown on the left, and flows into the plane of the drawing in a winding section shown on the right. A magnetic field produced hereby has the direction of the arrow A. For reasons of clarity, only a single stator winding 15 is shown, wherein stator windings are normally arranged uniformly along the whole circumference of the stator. The rotor 20 is excited by means of permanent magnets or rotor windings (not shown) for example, and has a magnetic field which is oriented in the longitudinal direction of the rotor as shown by the arrow B. A force between the stator 10 and the rotor 20 is proportional to sin(α), wherein α corresponds to the angle between the magnetic field A produced by the stator 10 and the magnetic field B produced by the rotor 20.

A prevailing orientation of the rotor 20 or of the magnetic field B produced thereby can be determined with the help of an angular sensor system 30. As the actual mounting position of the angular sensor system 30 within the electric machine 1 can vary from a required mounting position, the orientation angle determined by the angular sensor system 30, which is passed from the angular sensor system 30 to a controller of the electric machine 1 for example, can also differ from the actual orientation angle of the rotor. This angular difference is referred to as the offset angle and can be determined for the first time by means of the angular sensor system 30 by calibration after the electric machine 1 has been assembled.

During the subsequent operation of the electric machine 1, the electric machine 1 is activated with the help of a controller in each case in such a way that a strength and orientation of the magnetic fields A, B produced by the stator 10 and the rotor 20 are established with respect to one another in such a way that required torques are produced by the electric machine 1. The information relating to the prevailing orientation angle of the rotor 20 provided by the angular sensor system 30 taking into account the offset angle is hereby called upon to control the electric machine 1.

In order to determine the offset angle at a later point in time or to check the plausibility of the previously assumed offset angle, the system waits until the controller tries to bring the electric machine into a quasi zero-current state. For this purpose, the controller will adjust the voltages, which are applied to the windings of the electric machine, in such a way that they just correspond to the currently prevailing magnet wheel voltage in the electric machine, so that substantially no electric currents should flow in the windings.

In order to check whether the quasi zero-current state instructed by the controller is actually achieved, that is to say whether the offset angle assumed by the controller still corresponds to the offset angle actually prevailing in the electric machine, a voltage indicator is transformed into a coordinate system 40 which is fixed with respect to the rotor, as shown in FIG. 2. In such a coordinate system 40 which is fixed with respect to the rotor, the voltage indicator can be represented as a vector X. The coordinate system 40 specifies a component d on its abscissa and a component q of the voltage vector X on its ordinate. If the offset angle assumed by the controller is correct, the voltage vector X should be aligned along the ordinate, that is to say have only a component q. However, if the assumed offset has an angular error, a component d also results when the voltage vector is transformed into the coordinate system 40 which is fixed with respect to the rotor. The angle γ, which results from the deviation of the angle β of the voltage vector X within the coordinate system 40 from 90° (i.e. γ=90°−β), then corresponds to the angular error and can be calculated by an arctan function with one or two arguments, i.e. arctan (z) or arctan2 (y, x), for example γ=arctan d/q. This enables the calibrated offset angle or the offset angle provided by the angular sensor system to be checked for plausibility and corrected.

FIG. 3 shows schematically an electric vehicle 50, in which an electric machine 1 is controlled by a control device 60 in order to produce a required torque and transmit it via a shaft 70 to wheels 80 of the vehicle. Here, the control device 60 can be software-controlled and instructed by an appropriate computer program to carry out the method for determining an offset angle described above as required or at a suitable opportunity.

1. A method for determining an offset angle in an electric machine (1) having a stator (10) and a rotor (20), the method comprising:
activation of the electric machine in a quasi zero-current state in such a way that substantially no current flows in the windings of the electric machine;
determination of a voltage vector (X) which specifies a direction of a voltage activated in the electric machine during the quasi zero-current state;
transformation of the voltage vector into a coordinate system (40) which is fixed with respect to the rotor; and
determination of the offset angle based on the transformed voltage vector.

2. The method as claimed in claim 1, wherein the voltage vector is transformed into the coordinate system which is fixed with respect to the rotor in such a way that a component d and a component q are to be assigned to the voltage vector in a stationary state, wherein the offset angle is calculated from at least one of the component d and the component q.

3. The method as claimed in claim 2, wherein an angular error (γ) of the offset angle is calculated from the component d and the component q by forming an arctan value.

4. The method as claimed in claim 1, wherein the electric machine is activated during the quasi zero-current state in such a way that substantially no torque is transmitted from the electric machine to a shaft (70) connected to the electric machine.

5. The method as claimed in claim 1, wherein the electric machine is mechanically securely coupled to a shaft during the quasi zero-current state.

6. A device (60) for determining an offset angle in an electric machine (1) having a stator (10) and a rotor (20), wherein the device is designed to carry out the method as claimed in claim 1.

7. The device as claimed in claim 6, wherein the device is designed to recognize when the electric machine is activated in a quasi zero-current state in such a way that substantially no current flows in the windings of the electric machine, and is further designed to determine a voltage vector, to transform the voltage vector into a coordinate system which is fixed with respect to the rotor, and to calculate an offset angle of the electric machine based on the transformed voltage vector.

8. An electric vehicle (50) having a device as claimed in claim 6.

9. A computer program which is designed to determine an offset angle of an electric machine in accordance with a method as claimed in claim 1 when executed on a computer.

10. A non-transitory computer-readable storage medium having a computer program as claimed in claim 9 stored thereon.
